(19) United States
(12) Patent Application Publication
(10) Pub. No.: US 2024/0104108 A1
(43) Pub. Date: Mar. 28, 2024

(54) Granular Signals for Offline-to-Online Modeling

(71) Applicant: Google LLC, Mountain View, CA (US)

(72) Inventor: Loc Do, Irvine, CA (US)

(21) Appl. No.: 18/013,062

(22) PCT Filed: Nov. 9, 2021
(86) PCT No.: PCT/US2021/058600

§ 371 Date: Dec. 27, 2022

(51) Int. Cl. G06F 16/248

(52) U.S. Cl. CPC G06F 16/248

(57) ABSTRACT

Example aspects of embodiments of the present disclosure provide an example computer-implemented method. The example method includes receiving source activity data. The example method includes executing a query for target activity related to the source activity data. In the example method, executing the query includes determining, using a first machine-learned model of a machine-learned model framework, predicted target activity related to the source activity data. In the example method, executing the query includes generating, using a second machine-learned model of the machine-learned model framework, a predicted temporal distribution of target activity. The example method includes outputting, in response to the query, query results based at least in part on the predicted target activity and the predicted temporal distribution of target activity.

### FIELD

The present disclosure relates generally to generating associations using machine-learned models. More particularly, example aspects of the present disclosure relate to generating associations between online and offline activity using a machine-learned model framework.

### BACKGROUND

Some service providers may offer cross-platform services to users or customers. In some examples, the cross-platform services may include services provided on one service avenue (e.g., an online system) that has restricted communications with another service avenue (e.g., another system, a physical service outlet, etc.). It may be desired to associate data records of activity in the one avenue with activity in the other avenue for providing an improved cross-platform service.

### SUMMARY

Aspects and advantages of embodiments of the present disclosure will be set forth in part in the following description, or can be learned from the description, or can be learned through practice of the embodiments.

In one example aspect, the present disclosure provides for an example computer-implemented method. The example method includes receiving, by a computing system including one or more processors, tagged records. In the example method, the tagged records include linked source activity and linked target activity. The example method includes updating, by the computing system and using the tagged records, one or more parameters of a first machine-learned model configured to output data descriptive of target activity associated with source activity. The example method includes updating, by the computing system and using the tagged records, one or more parameters of a second machine-learned model configured to output a distribution of the target activity over time.

In one example aspect, the present disclosure provides for another example computer-implemented method. The example method includes receiving, by a computing system including one or more processors, source activity data. The example method includes executing, by the computing system, a query for target activity related to the source activity data. In the example method, executing the query includes determining, by the computing system and using a first machine-learned model of a machine-learned model framework, predicted target activity related to the source activity data. In the example method, executing the query includes generating, by the computing system and using a second machine-learned model of the machine-learned model framework, a predicted temporal distribution of target activity. The example method includes generating, by the computing system and in response to the query, query results based at least in part on the predicted target activity and the predicted temporal distribution of target activity.

In one example aspect, the present disclosure provides for an example system. The example system includes one or more processors and one or more memory devices storing computer-readable instructions. In the example system, the instructions, when implemented, cause the one or more processors to perform operations. In the example system, the operations include receiving source activity data. in the example system, the operations include executing a query for target activity related to the source activity data. In the example system, executing the query includes determining, using a first machine-learned model of a machine-learned model framework, predicted target activity related to the source activity data. In the example system, executing the query includes generating, using a second machine-learned model of the machine-learned model framework, a predicted temporal distribution of target activity. In the example system, the operations include generating, by the computing system and in response to the query, query results based at least in part on the predicted target activity and the predicted temporal distribution of target activity.

In one example aspect, the present disclosure provides for an example computer-readable medium storing computer-readable instructions that, when implemented, cause one or more processors to perform operations. In the example computer-readable medium, the operations include receiving source activity data. In the example computer-readable medium, the operations include executing a query for target activity related to the source activity data. In the example computer-readable medium, executing the query includes determining, using a first machine-learned model of a machine-learned model framework, predicted target activity related to the source activity data. In the example computer-readable medium, executing the query includes generating, using a second machine-learned model of the machine-learned model framework, a predicted temporal distribution of target activity. In the example computer-readable medium, the operations include generating, by the computing system and in response to the query, query results based at least in part on the predicted target activity and the predicted temporal distribution of target activity.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example system for processing a query over datasets according to example aspects of the present disclosure;

FIG. 2 depicts an example embodiment of a query processing subsystem for processing a query over datasets according to example aspects of the present disclosure;

FIG. 3 depicts an example processing system for processing a query over datasets according to example aspects of the present disclosure;

FIG. 4 depicts a flowchart of an example method for processing a query over datasets according to example aspects of the present disclosure;

FIG. 5 depicts a flowchart of another example method for processing a query over datasets according to example aspects of the present disclosure; and

FIG. 6 depicts a flowchart of an example method for training a system for processing a query over datasets according to example aspects of the present disclosure.

Reference numerals that are repeated across plural figures are intended to identify the same features in various implementations.

### DETAILED DESCRIPTION

### Overview

Generally, the present disclosure is directed to techniques for relating activity data from a source platform with target activity in an avenue different from the source platform. In some embodiments, the source activity data can describe interactions with content on a source computing system (e.g., a system hosting content for a service provider). The target activity can, in some embodiments, be related to the subject content for the source activity data, but in some scenarios, the source platform may not have visibility of the target activity for determining the relationship. For example, source activity can include interaction with an online service, and target activity can include visiting a physical location associated with the online service—in some scenarios, the online platform may not have communication with the physical location that indicates information about any visits.

Advantageously, systems and methods according to example aspects of the present disclosure can enable, for example, the service provider to execute queries over the source activity data to obtain data descriptive of target activity associated with (e.g., resulting from, responsive to, etc.) the source activity. For example, in some embodiments, the service provider associated with the online platform in the above scenario can execute a query over the activity data on the online platform to obtain data descriptive of visits to the physical location. The obtained query result can include a set of conversion label information (e.g., indicating source activity “converted” to target activity, etc.). In some examples, the set of conversion label information can correspond to a distribution over time. For instance, the distribution over time can indicate a “lag” between the source activity and any subsequent conversion to target activity. In some examples, each lag value (e.g., sampled from an output distribution) corresponds to a probability for target activity having that lag value. In this manner, for example, systems and methods according to example aspects of the present disclosure can enable processing queries for related target activity over a set of source activity data (e.g., when such query results may otherwise be unavailable).

In some embodiments, the systems and methods according to example aspects of the present disclosure can obtain the above advantages using a machine-learned model framework to process the queries over the source activity data. In some embodiments, the systems and methods according to example aspects of the present disclosure leverage a two-model structure in the machine-learned model framework. For example, the machine-learned model framework can include a conversion model and a lag model. Each model can be trained over a set of tagged records, such as source activity data and lag times for subsequent conversions labeled or otherwise linked as corresponding to one another. In this manner, for example, the machine-learned model framework can use the tagged (e.g., labeled) data to learn to use the conversion model to obtain target activity label information over a set of unlabeled source activity data, to use the lag model to obtain lag time(s) for any subsequent target activity, and thereby obtain results to queries for related target activity over a set of source activity data (e.g., when such query results may otherwise be unavailable).

Example systems and methods according to example aspects of the present disclosure can provide a variety of technical effects and benefits. For example, in some embodiments, example systems and methods can enable the processing of queries for related events in data-limited contexts that would otherwise lack sufficient data for returning usable query results. The processing of queries can be enabled by, for instance, using the machine-learned model framework of the present disclosure to index one or more source activity events as corresponding to one or more target activity events according to one or more parameters of the machine-learned model framework.

In some embodiments, example systems and methods can permit query results to be obtained with less time, effort, and/or expense (e.g., computational expense) by employing the machine-learned model framework to obtain conversion and lag results over a set of source activity data (e.g., even where direct target activity mapping may be generally unavailable). For example, by learning a set of parameters for the machine-learned model framework over a smaller set of known indexed data, and using the learned set of parameters to determine a relevance between unindexed source activity inputs to target activity outputs, example systems and methods can expand the capability of database processing systems to determine relations between activity data (e.g., between unindexed online and offline activity).

In some embodiments, example systems and methods according to example aspects of the present disclosure can provide for improved storage, management, retrieval, and cross-referencing of data structures in a memory (e.g., in a database). For instance, an example database may contain real-world data structures descriptive of various unlabeled source activity instances. The example database (or another database) may also contain data. structures descriptive of tagged activity data instances, Based on the tagged data instances, an example computing system according to the present disclosure can learn an intermediate set of data structures (e.g., a set of learned parameters of the machine-learned model framework) to map the unlabeled source activity instances to subsequent target activity. Although the intermediate set of data structures may not necessarily be interpretable to a human observer (e.g., interpretable as cognizably representing the underlying real-world data), the intermediate set of data structures may be operable to cause the computing system executing the machine-learned model to learn to relate the set of unlabeled source activity instances with target activity label information and/or a temporal distribution of target activity. In this manner, for instance, otherwise unindexed and/or uncategorized source activity data without a structured relation to target activity data may advantageously be queried over by systems and methods according to the present disclosure, And in some embodiments, for instance, the intermediate set of data structures may function to provide for association of the unlabeled source activity instance data structures in the database with one or more conversion labels to enable improved storage and/or retrieval of those data structures (e.g., indexed storage based on the one or more labels, retrieval based on the one or more labels, etc.).

In some examples, the two-model framework of example embodiments of the present disclosure can in particular provide for improved storage, management, retrieval, and cross-referencing of data structures in a memory (e.g., in a database). For instance, by leveraging two distinct models for conversion labeling and lag determinations, the machine-learned model framework can achieve a modularity that permits greater options for reconfiguration, maintenance, troubleshooting, and updating query processing systems of the present disclosure. Furthermore, query processing systems of the present disclosure that leverage the two-model framework can be configured on-the-fly by replacing any one or both of the conversion model or the lag model with replacement model(s) trained for one or more special tasks. For instance, in some seasons, lag may be best determined differently from how it is best determined in other seasons. Accordingly, the two-model framework provides for a highly configurable query processing system for processing queries over unlabeled source activity data in a database.

In some embodiments, for instance, the intermediate set of data structures may function to provide for the processing and execution of a query over the set of unlabeled source activity instances. For instance, a query may include a query to obtain a predicted temporal distribution of target activity related to an input set of source activity. The unlabeled source activity instances might not include any value or label documenting a link to target activity. Advantageously, however, the intermediate set of data structures may function to map the input source activity data to an output data structure containing the object of the query: a temporal distribution of target activity related to an input set of source activity. In this manner, for example, example systems and methods according to aspects of the present disclosure can provide for the execution and processing of queries over an input dataset even when such queries might not be available otherwise (e.g., due to data-poor or communication-restricted implementations).

In some embodiments, example systems and methods according to example aspects of the present disclosure can provide for determining a relevance among a set of unlabeled source activity data. For example, a relevance may he determined along a dimension for which there is no or incomplete labeling in the source activity data. For instance, a temporal relevance may be determined over the source activity data even when the source activity data might lack complete (or any) labeling of temporal relationships. For example, in some embodiments, the source activity data can include a timestamp (e.g., date, time, date and time, etc.) associated with the source activity, but the source activity data might lack timestamps for any subsequent target activity. Advantageously, example systems and methods according to example aspects of the present disclosure can provide for determining a relevance among the source activity data according to a temporal dimension of any subsequent target data (e.g., for which label information may be lacking). For instance, example systems and methods according to example aspects of the present disclosure can provide for determining a temporal relationship of a time window (e.g., data descriptive of source activity instances all determined to have converted within a given time window, such as a count, etc.).

As illustrated herein, example systems and methods of the present disclosure provide improvements to data storage, indexing, query processing, and results retrieval, which can in turn improve the ability of a computing system to relate data structures (e.g., by indexing previously unlabeled real-world data for querying), increase computational efficiency (e.g., by returning fewer null query results due to unlabeled data), and decrease computational cost (e.g., by predicting label information for unlabeled data instead of requiring additional data gathering), in some examples.

### Example Systems and Methods

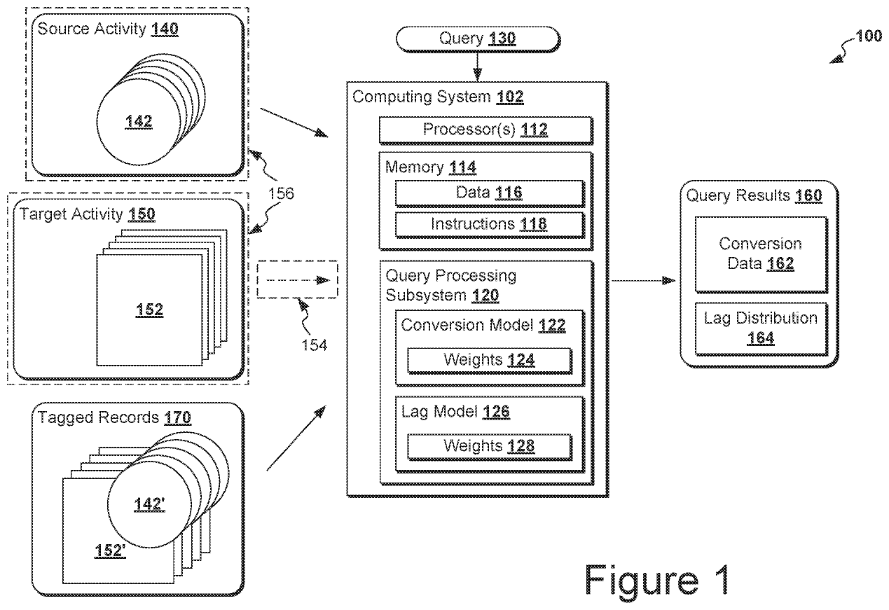

With reference now to the Figures, example embodiments of the present disclosure will be discussed in further detail. FIG. 1 depicts one example system 100 for processing example queries according to example aspects of the present disclosure. The example system 100 contains a computing system 102. The computing system 102 can be any type of system of one or more computing devices. A computing device can be, for example, a personal computing device (e.g., laptop or desktop), a mobile computing device (e.g., smartphone or tablet), a gaming console or controller, a wearable computing device, an embedded computing device, a server computing device, a node of a distributed computing device, a virtual instance hosted on a shared server, or any other type of computing device. In some embodiments, the computing system 102 includes a plurality of computing devices interconnected via a network or otherwise distributed in an interoperable manner. For example, the computing system 102 can include a server for serving content over a network (e.g., network 180). For instance, the computing system 102 can include a web server for hosting web content, for collecting data regarding web content (e.g., for receiving, monitoring, generating, or otherwise processing data regarding web content, such as the use, download of, and/or interaction with web content).

The computing system 102 can contain processor(s) 112 and memory 114. The one or more processors 112 can he any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the computing system 102 to perform operations.

In some implementations, the client computing system 102 can store or otherwise implement one or more machine-learned models of a machine-learned model framework. In some embodiments, the query processing subsystem 120 comprises a two-model machine-learned model framework. The machine-learned model framework can include a machine-learned conversion model 122 (e.g., with learnable weights 124), a machine-learned lag model 126 (e.g., with learnable weights 128). One or more of the machine-learned models can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

Embodiments of the example system 100 may be configured, as shown in FIG. 1, to process a query 130 over source activity 140 (e.g., containing source activity events 142) regarding the target activity 150 (e.g., containing target activity events 152). Responsive to processing the query 130, the computing system 102 can output query results 160. In some embodiments, query results 160 can include conversion data 162 (e.g., output from the conversion model 122 according to the weights 124) and lag distribution 164 (e.g., output from the lag model 126 according to the weights 128). The query 130 can be processed using tagged records 170, which contains linked source activity events 142′ and linked target activity events 152′.

In some embodiments, the query 130 is entered into an input of the computing system 102. For example, in some embodiments, the query processing subsystem 120 can be configured to process various queries 130 as input to the computing system 102. In some embodiments, the query 130 can be implicit in the structure and/or configuration of the query processing subsystem 120, For example, the query processing subsystem 120 can be configured to generate responses to queries for predicted temporal distributions of target activity. For example, the query processing subsystem 120 can be configured to generate responses to queries for data descriptive of the timing of target activity 130 subsequent and related to source activity 140.

In some embodiments, the source activity 140 includes unlabeled source activity events 142. Unlabeled source activity events 142 can include instances of substantially any kind or type of data that may be descriptive of various phenomena. In general, an instance refers to a set of one or more data values grouped together to describe a particular subject or subject matter. For example, an instance can be a feature vector. An instance can be associated with image data (e.g., a feature vector for an image, a hashed image, etc.). An instance can be associated with a measurement or other data collection event (e.g., at a particular time, or of a particular subject, or using a particular device, or from a particular perspective, etc.). In some examples, an instance of an unlabeled source activity event can be indicative of a communication from a source entity (e.g., a message in a content item).

An instance can be associated with a network session, such as a set of interactions with a web server. In some embodiments, an instance can be associated with a user's interaction with web content (e.g., anonymous or identified). In some embodiments, the unlabeled source activity events 142 might contain no label information for the instances. In some embodiments, the unlabeled source activity events 142 may contain some label information but may lack other label information. For example, the unlabeled source activity events 142 may lack a label determinative of or otherwise responsive to a query desired to be processed on the set of unlabeled source activity events 142.

For example, in some embodiments, source activity events 142 can contain data descriptive of a source platform and/or a content item on the platform that facilitated the event. Source activity events 142 can contain data descriptive of users and their role in the event, such as how long the user interacted with the platform and/or content item, what actions were taken by the user on the platform (e.g., what content was viewed, such as with a content ID, whether any products were added to a cart and/or purchased), where the user might generally be located, shipping location information, known or estimated user demographics, etc. In some embodiments, source activity events 142 can contain timing data. For example, timing data can include a date of an event (e.g., day, month, year, etc.), a duration of an event, local calendar features (e.g., holidays, seasons, traditional and/or expected patterns of behavior for various days/dates, etc.). In some examples, timing data can be input to all models of the query processing subsystem 120 (e.g., both the conversion model 122 and the lag model 126). In some examples, one or more elements of timing data is input only into the lag model 126.

In some embodiments, the source activity events 142 can be anonymized or otherwise obfuscated in the source activity 140. For example, source activity 140 can be reported to the computing system 102 in the aggregate (e.g., as a collection of aggregated events).

In some embodiments, target activity events 152 can include instances of substantially any kind or type of data that may be descriptive of various phenomena. In general, an instance refers to a set of one or more data values grouped together to describe a particular subject or subject matter. For example, an instance can be a feature vector. An instance can be associated with image data (e.g., a feature vector for an image, a hashed image, etc.). An instance can be associated with a measurement or other data collection event (e.g., at a particular time, or of a particular subject, or using a particular device, or from a particular perspective, etc.). An instance can be associated with a network session, such as a set of interactions with a web server. In some embodiments, an instance can be associated with a user's interaction with web content (e.g., anonymous or identified). In some examples, an instance of a target activity event can be indicative of receipt and/or response to a communication from a source entity (e.g., a message in a content item), Accordingly, in some embodiments, determining target activity related to source activity data can include estimating a read/viewed status of the communication(s) from the source entity. Similarly, in some embodiments, determining target activity related to source activity data can include determining recipients of the communication(s) from the source entity (e.g., “store visitors on day X were the likely recipients of online communication Y,” etc.). In this manner, for example, source activity and target activity can include communication(s) between a source platform and users, an

In some embodiments, target activity events 152 are not configured for a transmittal 154 to computing system 102. For example, target activity events 152 can be events not captured by data available to the computing system 102. Target activity events 152 can include visits at or other interactions with a physical location associated with a service provider. Target activity events 152 can include a user's interaction with a system (e.g., other than the source platform) not configured to transmit information through one or more of boundaries 156 (e.g., hardware boundaries, such as network boundaries, firewalls, ace, and/or policy boundaries, such as data sharing policies, data storage policies. etc.).

Query results 160 can include or be based on, for example, conversion data 162 and lag distribution 164. Conversion data 162 can include a set of target activity (e.g., a count of positive conversion labels). In some examples, conversion data 162 includes data descriptive of one or more features extracted (e.g., floated) from the input source activity 140 that are associated with positive conversions (e.g., a higher likelihood of positive conversions). In this manner, for example, one or more queries 130 can be executed over the source activity 140 for obtaining data associated with positive conversions.

Lag distribution 164 can include a distribution of target activity events 152 over time. The time(s) of the target activity events 152 can in some cases “lag” behind the time(s) of the source activity events 142 from which they arise. The lag distribution 164 can include a list of estimated lag time(s) for the target activity indicated in the conversion data 162, in some embodiments, the distribution 164 can include a histogram, for example. An example histogram of target activity events 152 can include a plurality of bins corresponding to timing data (e.g., date of event, time of event etc.) and a probability associated with the occurrence of target activity events 152 in that bin. In some embodiments, the bin(s) can be associated with an estimated count for the bin(s).

In some embodiments, the lag distribution 164 can be sampled from an intermediate output of the query processing system 120. For example, in some embodiments, the conversion model 122 outputs predicted target activity (e.g., a number of conversions from source activity to target activity), the lag model 126 outputs a distribution of probabilities of target activity over a number of days, and both outputs can be used for sampling to obtain a lag distribution 164.

For example, in some embodiments, the lag distribution 164 relates the conversion data 162 to a plurality of time periods. For example, the lag distribution 164 can include a data structure containing entries for a plurality of time periods and entries for conversion data 162 that the query processing subsystem 120 has associated with respective time periods of the plurality of time periods.

In some embodiments, the query processing subsystem 120 can be configured to process the query 130 using the tagged records 170, The tagged records 170 can include, for example, linked source activity events 142′ and linked target activity events 152′ (e.g., events respectively linked to each other). The source activity events 142′ can include source activity events as discussed above with respect to source activity events 142. Additionally, the source activity events 142′ can contain data linking them to target activity events 152′ (e.g., using a label, using one or more structural features of a data structure, etc.)+.

In some embodiments, the tagged records 170 can include subsets of source activity 140 and target activity 150. For example, source activity 140 may include source activity events 142 and linked source activity events 142′. For instance, a source platform may provide services to a plurality of users, only some of whom provide any indication of that user's participation in a corresponding target activity. For example, in some embodiments, a set of signed-in users (e.g., users associated with an account, such as an account with a service provider, the source platform, content on the source platform, etc.) might provide more information that non-signed-in users, and the signed-in users can provide information both regarding source activity and corresponding target activity (e.g., both associated with a user ID for the user). In some embodiments, the user ID is associated with a third-party system (e.g., a system different from the source platform system, a party other than the publisher of source content, etc.).

In some embodiments, the query processing subsystem 120 can contain a machine-learned model framework trained using the tagged records 170. For instance, the weights 124 and 128 of the conversion model 122 and lag model 126, respectively, can be learned (e.g., set, updated, adjusted, tuned, etc.) using the tagged records 170.

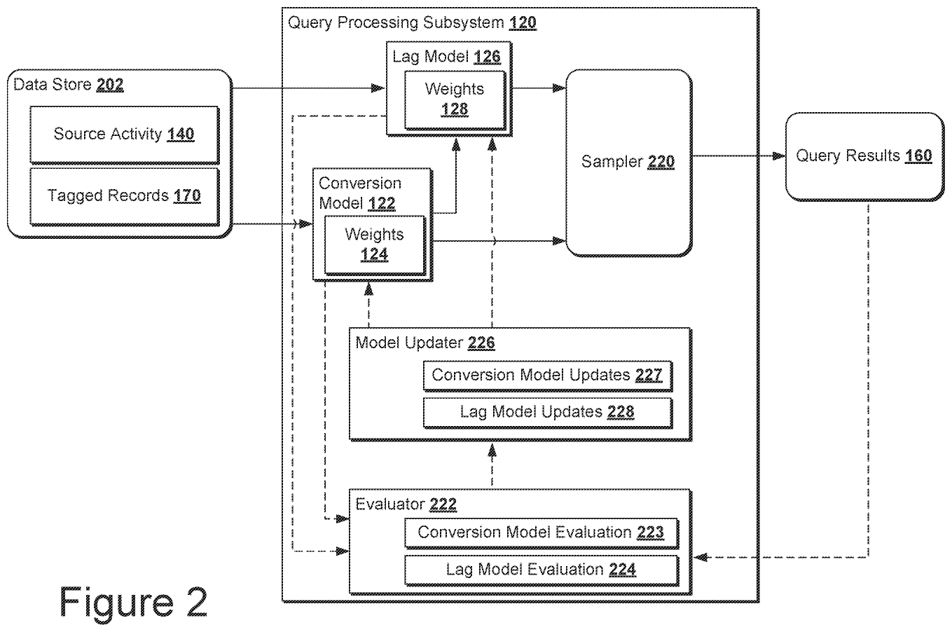

For instance, FIG. 2 depicts an example embodiment of a query processing subsystem 120 depicting inference (solid lines) and model updating (dashed lines) data flows. A data store 202 can contain source activity 140 and tagged records 170. During training, the query processing subsystem 120 can execute a query (e.g., a query 130) over the tagged records 170 to obtain query results 160. For instance, the conversion model 122 can generate target activity data using weights 124 (e.g., conversion data 162). The lag model 126 can generate lag data (e.g., lag distribution 164) using weights 128. In some embodiments, the outputs of the conversion model 122 and the lag model 124 are sampled by sampler 220 (e.g., randomly sampled, uniformly sampled, etc.) for providing the query results 160 (e.g., containing conversion data 162 and lag distribution 164).

The query results 160 can be used to update one or more of the weights 124 and the weights 128. For example, an evaluator 222 can evaluate the outputs 160, such as to determine whether the output query results 160 align with the tagged records 170. For instance, the evaluator 222 can determine an objective (e.g., a loss, a cost, a score, etc.) based on the query results 160. For instance, the evaluator 222 can compare the query results 160 to the tagged records 170, such as by comparing one or more predicted lag distributions to one or more measured lag times (e.g., by determining one or more measured time delays between linked source activity events 142′ and linked target activity events 152′, and comparing to the predicted time delays for the tagged records 170) and one or more measured counts of target activity. In this manner, for example, some embodiments may employ linked target activity events 152′ to form “ground truth” reference data for evaluation of predicted data descriptive of target activity events,

In some embodiments, the evaluator determines a conversion model evaluation 223 and a lag model evaluation 224. In some embodiments, the conversion model evaluation 223 and the lag model evaluation 224 are the same evaluation (e.g., include or are included in an objective, loss, cost, score, etc. for both the conversion model 122 and the lag model 126). In some embodiments, the conversion model evaluation 223 and the lag model evaluation 224 include different evaluations for each of the conversion model 122 and the lag model 126. For example, in some embodiments, the conversion model evaluation 223 can be based on a count and/or rate of predicted target activity output by the conversion model 122 (e.g., directly output from the conversion model 122 and/or as sampled via sampler 220, as is depicted in various options in dashed lines in FIG. 2). In some embodiments, a rate of predicted target activity can be determined with respect to a total amount of source activity (e.g., a ratio of target-activity-related source activity to the total amount of source activity, such as a “conversion rate,” etc.). For example, in some embodiments, the lag model evaluation 224 can be based on a distribution of probabilities output by the lag model 126 (e.g., directly output from the lag model 126 and/or as sampled via sampler 220, as is depicted in various options in dashed lines in FIG. 2).

Based at least in part on the evaluator 222, a model updater 226 can update one or more parameters of the weights 124 and/or the weights 128. For example, the model updater 280 can include or execute substantially any model update technique, such as gradient-based methods, evolutionary methods, etc. In some embodiments, the model updater 226 updates the weights 124 and the weights 128 together. In some embodiments, the model updater 226 implements conversion model updates 227 and lag model updates 228. In some embodiments, the conversion model updates 227 and lag model updates 228 are implemented independently (e.g., optionally together, but optionally with different evaluations, differently-configured model update techniques, such as with different hyperparameters, etc.).

In some embodiments, the evaluator 222 and the model updater 226 are contained within the computing system 102. In some embodiments, the evaluator 222 and/or the model updater 226 is external to the computing system 102 (e.g., and connected thereto, such as via a network or other intersystem communication protocol).

In this manner, for example, a machine-learned model framework can be trained according to example aspects of the present disclosure to obtain weights 124 and 128 that can provide for processing of queries against unlabeled source activity 140. For example, the weights may not necessarily be interpretable to a human observer (e.g., interpretable as cognizably representing the underlying real-world data), but may form a set of data structures functional to relate the unlabeled source activity events 142 a temporal distribution of target activity events 152 in response to a query for the same. In this manner, for instance, the data structures may function to enable improved processing of queries over otherwise unlabeled and unindexed source activity events 142. In this manner, for example, example implementations of the query processing systems and methods of the present disclosure can provide for expanding the capability of computing systems to perform queries where otherwise they might be incapable of doing so.

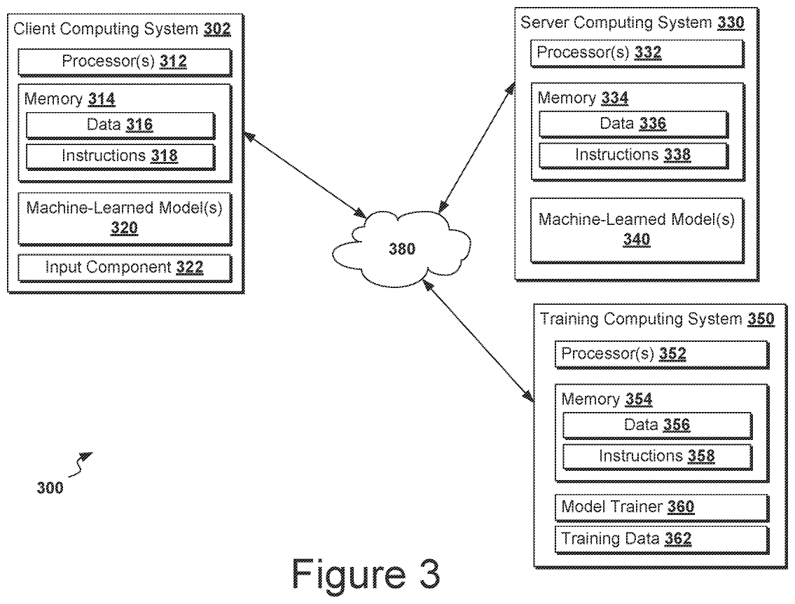

FIG. 3 depicts a block diagram of an example computing system 300 according to example embodiments of the present disclosure. The example system 300 includes a client computing system 302, a server computing system 330, and a training computing system 350 that are communicatively coupled over a network 380.

The client computing system 302 can be any type of system of one or more computing devices. A computing device can be, for example, a personal computing device (e.g., laptop or desktop), a mobile computing device (e.g., smartphone or tablet), a gaming console or controller, a wearable computing device, an embedded computing device, a server computing device, a node of a distributed computing device, a virtual instance hosted on a shared server, or any other type of computing device. In some embodiments, the client computing system 302 includes a plurality of computing devices interconnected via a network or otherwise distributed in an interoperable manner. For example, the client computing system 302 can include a server for serving content over a network (e.g., network 380). For instance, the client computing system 302 can include a web server for hosting web content, for collecting data regarding web content (e.g., for receiving, monitoring, generating, or otherwise processing data regarding web content, such as the use, download of, and/or interaction with web content).

In some embodiments, the client computing system 302 can be associated with a service provider and/or a source platform associated with, for example, source activity 140. For example, the client computing system 302 can be a source platform hosting content on behalf of a service provider. For instance, the client computing system 302 may host online content for a service provider who is also associated with target activity 150 (e.g., who has an offline presence, such as a physical location, for facilitating target activity 150). For example, the client computing system 302 can host first-party content. Source activity 140 can include interactions with the first-party content and can be measured as part of first-party measurement collection. For example, the first-party entity can be associated with publication of the first-party content.

The client computing system 302 includes one or more processors 312 and a memory 314. The one or more processors 312 can be any suitable processing device (e.g., a processor core, a microprocessor, an ASIC, an FPGA, a controller, a microcontroller, etc.) and can be one processor or a plurality of processors that are operatively connected. The memory 314 can include one or more non-transitory computer-readable storage media, such as RAM, ROM, EEPROM, EPROM, flash memory devices, magnetic disks, etc., and combinations thereof The memory 314 can store data 316 and instructions 318 which are executed by the processor 312 to cause the client computing system 302 to perform operations.

In some implementations, the client computing system 302 can store or include one or more machine-learned models 320. For example, the machine-learned model(s) 320 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models) 320 include a machine-learned model framework including a conversion model 122 and a lag model 126, such as discussed above with reference to FIGS. 1 and 2.

In some implementations, the one or more machine-learned models 320 can be received from the server computing system 330 over network 380, stored in the client computing system memory 314, and then used or otherwise implemented by the one or more processors 312. In some implementations, the client computing system 302 can implement multiple parallel instances of a single machine-learned model 320.

Additionally, or alternatively, one or more machine-learned models 340 (which may be the same as or different from machine-learned models 320) can be included in or otherwise stored and implemented by the server computing system 330 that communicates with the client computing system 302 according to a client-server relationship. For example, the machine-learned models 340 can be implemented by the server computing system 340 as a portion of a web service (e.g., a service for processing queries over source activity 140 according to any of the various aspects of the present disclosure). Example machine-learned model(s) 340 include a machine-learned model framework including a conversion model 122 and a lag model 126, such as discussed above with reference to FIGS. 1 and 2. Thus, one or more machine-learned models 320 can be stored and implemented at the client computing system 302 and/or one or more machine-learned models 340 can be stored and implemented at the server computing system 330.

In some embodiments, the server computing system 330 can configure the two-model framework of the query processing subsystem 120. For example, in some embodiments, the server computing system 330 can store one or more conversion model(s) 122 and/or one or more lag model(s) 126 (e.g., sets of one or more weights 124, weights 128, etc.) for replacing or substituting with one or more other conversion model(s) 122 and/or lag model(s) 126 for configuration and/or maintenance of the query processing subsystem 120. For example, in some embodiments, some conversion models or lag models might be broadly applicable, whereas some conversion models or lag models might offer improved performance in specific areas (e.g., specific kinds of subject activity, specific kinds of target activity, etc.), and the server computing system 330 can substitute and/or supplement the two-model framework of the query processing subsystem 120 to improve and configure processing of queries 130.

The client computing system 302 can also include one or more input components 322 that receives input (e.g., user input, input from other systems, etc.). For example, the input component 322 can be a touch-sensitive component (e.g., a touch-sensitive display screen or a touch pad) that is sensitive to the touch of an input object (e.g., a finger or a stylus). Other example input components include a microphone, a keyboard (e.g., physical and/or graphical), a network port (e.g., wireless, wired, etc.), a communication bus, and the like.

The server computing system 330 includes one or more processors 332 and a memory 334. The one or more processors 332 can be any suitable processing device (e.g., a processor core, a microprocessor, an ASIC, an FPGA, a controller, a microcontroller, etc.) and can be one processor or a plurality of processors that are operatively connected. The memory 334 can include one or more non-transitory computer-readable storage media, such as RAM, ROM, EEPROM, EPROM, flash memory devices, magnetic disks, etc., and combinations thereof The memory 334 can store data 336 and instructions 338 which are executed by the processor 332 to cause the server computing system 330 to perform operations.

In some implementations, the server computing system 330 includes or is otherwise implemented by one or more server computing devices. In instances in which the server computing system 330 includes plural server computing devices, such server computing devices can operate according to sequential computing architectures, parallel computing architectures, or some combination thereof.

As described above, the server computing system 330 can store or otherwise include one or more machine-learned models 340. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

In some embodiments, client computing system 302 has access to information unavailable to the server computing system 330 and/or the training computing system 350, In some embodiments, the client computing system 302 can be configured to host first-party content. First-party content can include, for example, content associated with the owner, operator, and/or beneficiary of the client computing system 302 (e.g., contractual beneficiary, such as a lessee of computing time on the client computing system 302). In some embodiments, the client computing system 302 may collect data (e.g., telemetry, analytics, usage statistics, logs, etc.) regarding the download, viewing, and use of first-party content (e.g., source activity 140). In some embodiments, the client computing system 302 may collect data regarding the download, viewing, and use of other content related to and/or linking to the first-party content and/or other services or aspects related to the client computing system or a beneficiary thereof In some embodiments, the server computing system 330 may not have full or unrestricted access to first-party content on the client computing system 302 or unrestricted access to data regarding the viewing and use of the content.

In some embodiments, neither the client computing system 302 nor the server computing system 330 has complete access to target activity 150. For example, in some scenarios, target activity 150 is not or cannot be recorded in its entirety. In some scenarios, complete target activity 150 (or, e.g., data descriptive thereof) is unavailable to the client computing system 302 and/or the server computing system 330. However, in some embodiments, the server computing system 330 may, for example, have access to tagged records 170, which can optionally include a tagged subset of target activity 150 as well as a tagged subset of source activity 140. For example, the server computing system 330 may be associated with a plurality of signed-in users who report their participation in both source activity 140 and target activity 150.

Accordingly, in some embodiments, one or more machine-learned models 340 may advantageously be trained according to example aspects of the present disclosure to associate the source activity 140 with target activity 150. For example, one or more machine-learned models 340 may be trained according to example aspects of the present disclosure to learn to generate the relationships between the source activity 140 and target activity 150 to obtain sets of weights (e.g., weights 124 and weights 128) for obtaining results to a query processed over the source activity 140.

The client computing system 302 and/or the server computing system 330 can train the models 320 and/or 340 via interaction with a training computing system 350 that is communicatively coupled over the network 380. The training computing system 350 can be separate from the server computing system 330 or can be a portion of the server computing system 330.

The training computing system 350 includes one or more processors 352 and a memory 354. The one or more processors 352 can be any suitable processing device (e.g., a processor core, a microprocessor, an ASIC, an FPGA, a controller, a microcontroller, etc.) and can be one processor or a plurality of processors that are operatively connected. The memory 354 can include one or more non-transitory computer-readable storage media, such as RAM, ROM, EEPROM, EPROM, flash memory devices, magnetic disks, etc., and combinations thereof. The memory 354 can store data 356 and instructions 358 which are executed by the processor 352 to cause the training computing system 350 to perform operations. In some implementations, the training computing system 350 includes or is otherwise implemented by one or more server computing devices.

The training computing system 350 can include a model trainer 360 that trains the machine-learned models 320 and/or 340 stored at the client computing system 302 and/or the server computing system 330 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over one or more training iterations. In some implementations, performing backwards propagation of errors can include performing truncated backpropagation through time. The model trainer 360 can perform one or more techniques (e.g., weight decays, dropouts, etc.) to improve a capability of the models being trained.

In particular, the model trainer 360 can train the machine-learned models 320 and/or 340 based on a set of training data 362. The training data 362 can include, for example, tagged records according to example aspects of the present disclosure (e.g., as discussed above, such as with reference to FIGS. 1 and 2).

In some implementations, the training data 362 can include data provided or otherwise obtained by the client computing system 302. Thus, in such implementations, the model 320 provided to the client computing system 302 and/or the model 340 provided to the server computing system 330 can be trained by the training computing system 350 on data received from the client computing system 302. In some embodiments, the training data 362 includes data not otherwise accessible by the server computing system 330 and/or the training computing system 350 except as provided by the client computing system 302.

The model trainer 360 includes computer logic utilized to provide desired functionality. The model trainer 360 can be implemented in hardware, firmware, and/or software controlling a general-purpose processor. For example, in some implementations, the model trainer 360 includes program files stored on a storage device, loaded into a memory and executed by one or more processors. In other implementations, the model trainer 360 includes one or more sets of computer-executable instructions that are stored in a tangible computer-readable storage medium such as RAM, hard disk, or optical or magnetic media.

The network 380 can be any type of communications network, such as a local area network (e.g., intranet), wide area network (e.g., Internet), or some combination thereof and can include any number of wired or wireless links. In general, communication over the network 380 can be carried via any type of wired and/or wireless connection, using a wide variety of communication protocols (e. g., TCP/IP, HTTP, FTP), encodings or formats (e.g., HTML, XML), and/or protection schemes (e.g., VPN, secure HTTP, SSL).

The machine-learned models described in this specification (e.g., models 120, 320, 340, etc.) may be used in a variety of tasks, applications, and/or use cases. In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data., etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data. to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data. to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data, and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may include a text output which is mapped to the spoken utterance. In some cases, the task comprises encrypting or decrypting input data. In some cases, the task comprises a microprocessor performance task, such as branch prediction or memory address translation.

In some embodiments, any of the inputs described above may be provided for a labeling task or other indexing task. For example, any of the inputs described above, or other inputs, may be or comprise instances, such as unlabeled instances (e.g., lacking some or all labeling, such as lacking a desired labeling). In some embodiments, the task is to process a query against the input instances. The output (e.g., or an intermediate output) can include a data structure relating the unlabeled instances with one or more values indicating a relation to a query label. In this manner, tier example, the task can be an indexing task, to index unlabeled instances for the processing of queries on label data (e.g., label data regarding labels not previously associated with the instances). The output can include a count or other summary output descriptive of the relationship(s) between the unlabeled instances and the query label(s). The output can include a retrieval of the unlabeled instance(s) determined as relevant to the query label(s). In some embodiments, the index may be transient (e.g., stored to obtain various metrics and/or analytics from processing queries against the indexed instances and later offloaded) or stored for a longer than transient duration (e.g., written to disk, etc.).

FIG. 3 illustrates one example computing system that can be used to implement the present disclosure. Other computing systems can be used as well. For example, in some implementations, the client computing system 102 can include the model trainer 160 and the training dataset 162. In such implementations, the models 120 can be both trained and used locally at the client computing system 102. In some of such implementations, the client computing system 102 can implement the model trainer 160 to personalize the models 120 based on user-specific data.

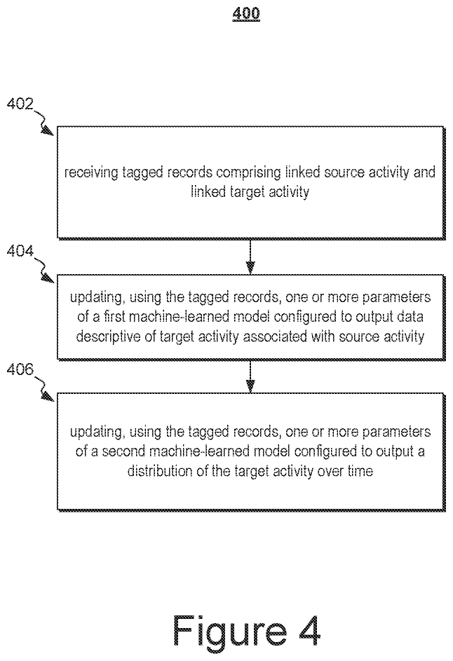

FIG. 4 depicts a flow chart diagram of an example method 400 to perform according to example embodiments of the present disclosure. Although FIG. 4 depicts steps performed in a particular order for purposes of illustration and discussion, the methods of the present disclosure are not limited to the particularly illustrated order or arrangement. The various steps of the example method 400 can be omitted, rearranged, combined, and/or adapted in various ways without deviating from the scope of the present disclosure.

At 402, the example method 400 includes receiving tagged records. In example method 400, the tagged records can include linked source activity and linked target activity. For instance, the tagged records can include tagged records 170.

At 404, the example method 400 includes updating, using the tagged records, one or more parameters of a first machine-learned model. In example method 400, the first machine-learned model is configured to output data descriptive of target activity associated with source activity. For instance, the first machine-learned model can include a conversion model (e.g., conversion model 122) for determining conversions from source activity (e.g., activity on a source platform, such as source activity 140) to related target activity (e.g., activity in another avenue related to subject of the source activity). In some embodiments, the source activity data includes data descriptive of online activity and the target activity comprises offline activity. In some embodiments, the source activity data includes data descriptive of online activity and the target activity comprises online activity.

At 406, the example method 400 includes updating, using the tagged records, one or more parameters of a second machine-learned model. In the example method 400, the second machine-learned model is configured to output a distribution of the target activity over time. For instance, the second machine-learned model can include a lag model (e.g., lag model 126) for determining a temporal distribution of target activity flowing from or otherwise related to the source activity.

In some embodiments of example method 400, the first machine-learned model and the second machine-learned model are part of a machine-learned model framework configured to process queries over source activity data. For example, in some embodiments, processing queries includes receiving source activity data. In some embodiments, the source activity data can be associated with the linked source activity. For instance, in some embodiments, the linked source activity forms a subset of the source activity data (e.g., a subset of otherwise unlinked source activity data is linked to target activity). In some embodiments, the source activity data includes data descriptive of online activity on a source system, and communication with the source system is restricted from indicating a link between the source activity data and target activity. In some embodiments, processing queries includes determining, using the first machine-learned model, predicted target activity related to the source activity data. in some embodiments, processing queries includes generating, using the second machine-learned model, a predicted temporal distribution of target activity. In some embodiments, processing queries includes generating, in response to the query, query results based at least in part on the predicted target activity and the predicted temporal distribution of target activity. In some embodiments, generating results to the queries includes sampling an output of the second machine-learned model. In some embodiments, the query results include a data structure relating the predicted target activity to a plurality of time periods.

In some embodiments of example method 400, the first machine-learned model and the second machine-learned model are trained using different updates. For example, in some embodiments, the one or more parameters of the first machine-learned model are updated independently of the one or more parameters of the second machine-learned model. For example, in some embodiments, updating the one or more parameters includes updating one or more first parameters of the first machine-learned model based at least in part on a target activity count over the training set of predicted target activity. In some embodiments, updating the one or more parameters includes updating one or more second parameters of the second machine-learned model based at least in part on the predicted temporal distribution of target activity,

In some embodiments of the example method 400, the first machine-learned model and the second machine-learned model each receive the same set of input signals. In some embodiments, an input to the second machine-learned model includes a date (e.g., in addition to the set also provided to the first machine-learned model). In some embodiments, an output of the first machine-learned model is input to the second machine-learned model. In some embodiments, the output of the first machine-learned model includes a target activity count.

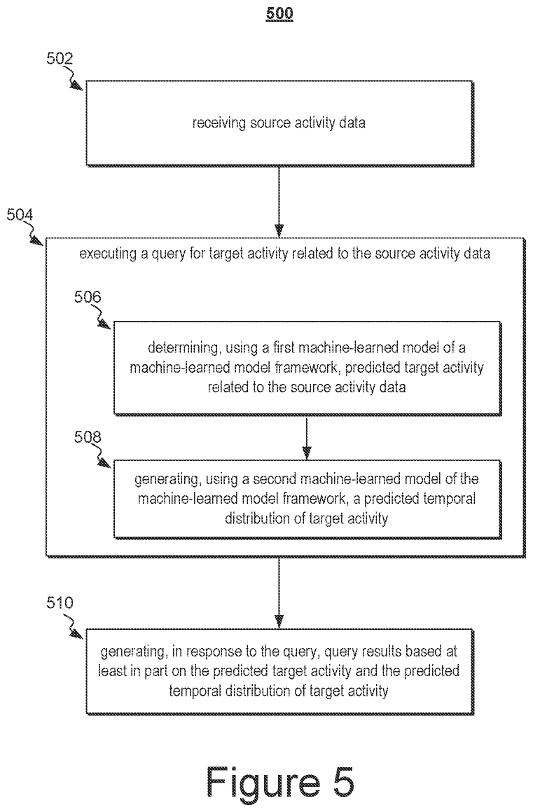

FIG. 5 depicts a flow chart diagram of an example method 500 to perform according to example embodiments of the present disclosure. Although FIG. 5 depicts steps performed in a particular order for purposes of illustration and discussion, the methods of the present disclosure are not limited to the particularly illustrated order or arrangement. The various steps of the example method 500 can be omitted, rearranged, combined, and/or adapted in various ways without deviating from the scope of the present disclosure.

At 502, example method 500 includes receiving source activity data. In some embodiments, source activity data (e.g., source activity 140) includes data descriptive of online activity. In some embodiments, source activity data includes data descriptive of online activity associated with a first-party platform (e.g., client computing device 302).

At 504, example method 500 includes executing a query for target activity related to the source activity data, in some embodiments, the target activity includes offline activity. In some embodiments, the query is an implicit query (e.g., implicit in the structure and/or machine-learned framework of a query processing subsystem, such as query processing subsystem 120).

At 506, executing the query includes determining, using a first machine-learned model of a machine-learned model framework, predicted target activity related to the source activity data. In some embodiments, the output of the first machine-learned model includes a target activity count (e.g., an estimated quantity of target activity events).

At 508, executing the query includes generating, using a second machine-learned. model of the machine-learned model framework, a predicted temporal distribution of target activity (e.g., target activity 150). In some embodiments, the output of the second machine-learned model includes a distribution (e.g., a probability distribution) of target activity over time.

At 510, the example method 500 includes generating, in response to the query, query results (e.g., query results 160) based at least in part on the predicted target activity and the predicted temporal distribution of target activity. In some embodiments, the query results can include data descriptive of a distribution of predicted target activity over time. In some embodiments, the query results include a data. structure relating the predicted target activity to a plurality of time periods, In some embodiments, generating the query results includes sampling an output of the second machine-learned model.

In some embodiments of the example method 500, the first machine-learned model and the second machine-learned model are trained using different updates. For instance, in some embodiments, updating the one or more parameters includes updating one or more first parameters of the first machine-learned model based at least in part on a target activity count over the training set of predicted target activity, updating one or more second parameters of the second machine-learned model based at least in part on the predicted temporal distribution of target activity.

In some embodiments of the example method 500, the first machine-learned model and the second machine-learned model each receive the same set of input signals. In some embodiments, an input to the second machine-learned model includes a date (e.g., in addition to the set also provided to the first machine-learned model). In some embodiments, an output of the first machine-learned model is input to the second machine-learned model. In some embodiments, the output of the first machine-learned model includes a target activity count.

In some embodiments of the example method 500, the source activity data includes data descriptive of online activity on a source system, and communication with the source system is restricted from indicating a link between the source activity data and target activity.

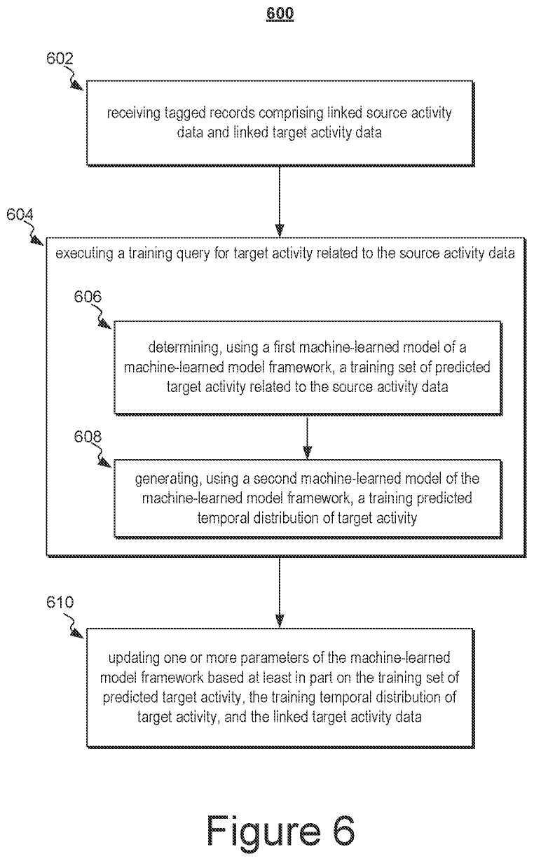

FIG. 6 depicts a flow chart diagram of an example method 600 to train an example machine-learned model framework according to example embodiments of the present disclosure (e.g., to train a query processing subsystem 120, such as to perform example methods 400 and/or 500). Although FIG. 6 depicts steps performed in a particular order for purposes of illustration and discussion, the methods of the present disclosure are not limited to the particularly illustrated order or arrangement. The various steps of the example method 600 can be omitted, rearranged, combined, and/or adapted in various ways without deviating from the scope of the present disclosure.

Example method 600 can include any one or more portions of example method 400 and/or example method 500. For example, example method 600 and be included in or precede example method 400 and/or example method 500.

For instance, at 602, the example method 600 includes receiving tagged records. In some embodiments, tagged records (e.g., tagged records 170) can include source activity data (e.g., as received at 502), in example method 600, tagged records include linked source activity data and linked target activity data (e.g., source activity data linked to target activity events).

At 604, the example method 600 includes executing a training query for target activity related to the source activity. In some embodiments of example method 600, executing the training query includes determining, using the first machine-learned model, a training set of predicted target activity related to the linked source activity data. In some embodiments of example method 600, executing the training query includes generating, using the second machine-learned model, a training temporal distribution of target activity.

At 610, the example method 600 includes updating one or more parameters of the machine-learned model framework based at least in part on the training set of predicted target activity, the training temporal distribution of target activity, and the linked target activity data. For example, in some embodiments, the first machine-learned model and the second machine-learned model are trained using different updates. In some embodiments, for instance, updating the one or more parameters includes updating one or more first parameters of the first machine-learned model based at least in part on a target activity count over the training set of predicted target activity. In some embodiments, for instance, updating the one or more parameters includes updating one or more second parameters of the second machine-learned model based at least in part on the predicted temporal distribution of target activity.

### Additional Disclosure

The technology discussed herein refers to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method, comprising:
receiving, by a computing system comprising one or more processors. source activity data;
executing, by the computing system, a query for target activity related to the source activity data, wherein executing the query comprises:
determining, by the computing system and using a first machine-learned model of a machine-learned model framework, predicted target activity related to the source activity data; and
generating, by the computing system and using a second machine-learned model of the machine-learned model framework, a predicted temporal distribution of target activity; and
generating, by the computing system and in response to the query, query results based at least in part on the predicted target activity and the predicted temporal distribution of target activity.

2. (canceled)

3. The computer-implemented method of claim 1, wherein generating the query results comprises sampling an output of the second machine-learned model.

4. The computer-implemented method of claim 1, wherein the query results comprise a data structure relating the predicted target activity to a plurality of time periods.

5. The computer-implemented method of claim 1, wherein the first machine-learned model and the second machine-learned model are trained using different updates.

6. The computer-implemented method of claim 1, wherein updating the one or more parameters comprises:
updating, by the computing system, one or more first parameters of the first machine-learned model based at least in part on a target activity count over a training set of predicted target activity; and
updating, by the computing system, one or more second parameters of the second machine-learned model based at least in part on the predicted temporal distribution of target activity.

7. The computer-implemented method of claim 1, wherein the first machine-learned model and the second machine-learned model each receive the same set of input signals.

8. The computer-implemented method of claim 1, wherein an input to the second machine-learned model comprises a date.

9. The computer-implemented method of claim 1, wherein the source activity data comprises data descriptive of online activity on a source system, and wherein communication with the source system is restricted from indicating a link between the source activity data and target activity.

10. The computer-implemented method of claim 1, wherein an output of the first machine-learned model is input to the second machine-learned model.

11. The computer-implemented method of claim 10, wherein the output of the first machine-learned model comprises a target activity count.

12. The computer-implemented method of claim 1, wherein the source activity data comprises data descriptive of online activity and the target activity comprises offline activity.

13. The computer-implemented method of claim 1, wherein the source activity data comprises data descriptive of online activity and the target activity comprises online activity.

14. A computer-implemented method, comprising:
receiving, by a computing system comprising one or more processors, tagged records comprising linked source activity and linked target activity;
updating, by the computing system and using the tagged records, one or more parameters of a first machine-learned model configured to output data descriptive of target activity associated with source activity; and
updating, by the computing system and using the tagged records, one or more parameters of a second machine-learned model configured to output a temporal distribution of the target activity, the second machine-learned model different than the first machine-learned model.

15. The computer-implemented method of claim 14, comprising:
receiving, by the computing system, source activity data, wherein the source activity data is associated with the linked source activity;
determining, by the computing system and using the first machine-learned model, predicted target activity related to the source activity data;
generating, by the computing system and using the second machine-learned model, a predicted temporal distribution of target activity; and
generating, by the computing system and in response to a query, query results based at least in part on the predicted target activity and the predicted temporal distribution of target activity.

16. The computer-implemented method of claim 15, wherein generating the query results comprises sampling, by the computing system, the predicted target activity and the predicted temporal distribution of target activity.

17. The computer-implemented method of claim 14, wherein the one or more parameters of the first machine-learned model are updated independently of the one or more parameters of the second machine-learned model.

18. The computer-implemented method of claim 14, wherein the first machine-learned model and the second machine-learned model each receive the same set of input signals.

19. The computer-implemented method of claim 14, wherein the source activity data comprises data descriptive of online activity on a source system, and wherein communication with the source system is restricted from indicating a link between the source activity data and target activity.

20. A system, comprising:
one or more processors; and
one or more memory devices storing computer-readable instructions that, when implemented, cause the one or more processors to perform operations, the operations comprising the method of any of the preceding claims.

21. The system of claim 20,
wherein the one or more memory devices store a learned data structure for executing queries according to any of the preceding claims, the learned data structure comprising first weights of the first machine-learned model and second weights of the second machine-learned model; and
wherein the operations comprise:
determining the predicted target activity by transforming a set of input signals using the learned data structure; and
generating the predicted temporal distribution of target activity by transforming the set of input signals using the learned data structure.

22. (canceled)
